(19) United States
(12) Patent Application Publication
(10) Pub. No.: US 2025/0236568 A1
(43) Pub. Date: Jul. 24, 2025

(54) PHOTOCURABLE AND COMBUSTIBLE COMPOSITION AND USE THEREOF

(71) Applicant: XI'AN MODERN CHEMISTRY RESEARCH INSTITUTE, Xi'an (CN)

(72) Inventors: Weitao Yang, Xi'an (CN); Minghui Xu, Xi'an (CN); Rui Hu, Xi'an (CN); Manman Li, Xi'an (CN); Yuchen Gao, Xi'an (CN)

(21) Appl. No.: 19/174,959

(22) Filed: Apr. 10, 2025

Related U.S. Application Data
(63) Continuation of application No. PCT/CN2023/094989, filed on May 18, 2023.

(30) Foreign Application Priority Data
Oct. 10, 2022 (CN) 202211233245.X

(51) Int. Cl. C06B 25/00; B33Y 70/00; B33Y 80/00; C06B 21/00; C06B 23/00; C08F 290/06

(52) U.S. Cl. CPC C06B 25/00; B33Y 70/00; B33Y 80/00; C06B 21/0058; C06B 23/009; C08F 290/062

(57) ABSTRACT

Disclosed is a photocurable and combustible composition, including an energetic prepolymer, a diluent and a photoinitiator; where the energetic prepolymer is one of or a mixture of two of acrylate-terminated poly(3-nitratomethyl-3-methyloxetane) and acrylate-terminated poly(glycidyl nitrate). The photocurable and combustible composition has an energetic group, i.e., a nitrate group, which can be subjected to self-sustaining combustion in an oxygen-free environment, and the composition can be used to prepare combustible components such as combustible ordnance components.

### CROSS-REFERENCE TO RELATED APPLICATION

The present application is a continuation application of International Application No. PCT/CN2023/094989, filed on May 18, 2023, which claims priority to Chinese Patent Application No. 202211233245.X, filed on Oct. 10, 2022. The contents of these applications are incorporated herein by reference in their entirety.

### TECHNICAL FIELD

The present disclosure relates to the field of processing and manufacturing of combustible components, in particular to a combustible composition based on DLP and SLA photocuring 3D printing and use thereof.

### BACKGROUND

Conventional preparation methods of combustible components include suction filter molding, rolling and pressing. There are many problems in the preparation of combustible components, including long manufacturing cycle, poor accuracy (+0.5 mm) and difficult demoulding of complex structures. Combustible components, such as combustible ordnance components, as a new type of ordnance products, have played an extremely important role in the history of the development of the world's weapons and ammunition. They have advantages of light weight and disappearance after combustion, and have become an important part of the army's weapons and equipment, and their impact on the improvement of the comprehensive performance of the weapons and equipment is constantly strengthening.

3D printing (additive manufacturing) is an advanced technology that builds objects by printing them layer by layer on the basis of digital model files. Among 3D printing methods, DLP (Digital Light Procession) and SLA (Stereo lithography Appearance) photocuring 3D printing methods are a kind of 3D printing technology based on ultraviolet curing, where the photosensitive resin is cured layer by layer under an ultraviolet laser with a specific wavelength and intensity, to build a three-dimensional entity. Compared with other 3D printing methods, they have advantages of high molding accuracy and good surface quality. Such kind of 3D printing technology can be used to prepare combustible components. Compared with the traditional molding methods of the above-mentioned combustible components, DLP and SLA photocuring 3D printing technology has an advantage of high precision and can be used to prepare combustible components with complex structures. Combustible component needs to serve as a container in a confined or limited space and can be subjected to self-sustaining combustion in an oxygen-free environment then disappears. However, the compositions currently available for DLP and SLA printing are inert compositions. It is urgent to develop a combustible composition that can be subjected to self-sustaining combustion in an oxygen-free environment.

### SUMMARY

Aiming at solving the defects or deficiencies of the prior art, a photocurable and combustible composition is provided herein.

The composition provided herein comprises an energetic prepolymer, a diluent and a photoinitiator;
the energetic prepolymer is one of or a mixture of two of acrylate-terminated poly(3-nitrato methyl-3-methyloxetane) (APNIMMO) and acrylate-terminated poly(glycidyl nitrate) (APGN);
the diluent is one of or a mixture of at least two of isobornyl acrylate, isobornyl methacrylate, ethoxylated oxyphenyl acrylate, ethoxylated ethoxyethyl acrylate, dipropylene glycol acrylate, tripropylene glycol diacrylate, hexadiol diacrylate, propoxylated glycerol triacrylate, trimethylol propane triacrylate, ethoxylated trimethylol propane triacrylate, alkoxyylated pentaerythritol tetraacrylate and dimethylol propane tetraacrylate;
the photoinitiator is one of or a mixture of at least two of ethyl 2,4,6-trimethylbenzoylphenylphosphonate, phenyl bis(2,4,6-trimethyl benzoyl) phosphine oxide and 2,4,6-trimethylbenzoyl-diphenyl phosphine oxide.

Optionally, a content of the energetic prepolymer is 30% to 80% by mass, a content of the diluent is 20% to 70% by mass, and a mass percentage sum of the energetic prepolymer and the diluent is 100%. The photoinitiator is comprised in an amount of 0.3% to 5% by mass, relative to a mass sum of the energetic prepolymer and the diluent.

The components of the composition of the disclosure have an energetic group, i.e., a nitrate group, so that the composition can be subjected to self-sustaining combustion in an oxygen-free environment. The composition can be used as a raw material for DLP and SLA photocuring 3D printing to prepare combustible components, such as a combustible ignition cartridge, a combustible cartridge/cylindrantherae and a combustible igniting primer. Thus, the manufacturing of combustible components no longer requires making of molds or large and complex forming equipment.

In addition, provided herein is a preparation method of a combustible component. In the preparation method, the photocurable and combustible composition above is used as a raw material, and the combustible component is prepared by a DLP photocuring 3D printing method or a SLA photocuring 3D printing method.

### BRIEF DESCRIPTION OF THE DRAWINGS

FIG. 1 is a schematic diagram illustrating a 3D model and a finished product of the combustible ignition cartridge prepared in Example 3;

FIG. 2 is a schematic diagram illustrating a 3D model and a finished product of the combustible cylindrantherae prepared in Example 4;

FIG. 3 is a nuclear magnetic resonance (NMR) spectrogram of the acrylate-terminated poly(glycidyl nitrate) used in the disclosure.

### DETAILED DESCRIPTION

Unless otherwise stated, scientific and technical terms herein are understood in accordance with the general understanding of ordinary persons skilled in the relevant field. It should also be understood that the temperature and concentration mentioned herein are approximate values, for illustrative purposes. Although similar or equivalent methods and materials as described herein may be used for the implementation of this disclosure, some suitable methods and materials are described below. The equipment, materials, methods, solution concentrations and examples described herein are illustrative only and are not intended to restrict this disclosure. In actual implementation, those skilled in the art can optimize the substance ratio, concentration and operation parameter values involved in the method according to the disclosed contents by conventional experimental means, to realize the purpose of the disclosure.

The terminal group of the energetic prepolymer in the composition of the disclosure is an acrylate group, so that the energetic prepolymer can be quickly cured under ultraviolet light. Besides, the energetic prepolymer contains a —ONO₂ energetic group in the side chain, which can realize the self-sustaining combustion of the composition in an oxygen-free environment. Therefore, the composition of this disclosure can be used as raw material to prepare a composition combustible component with a complex three-dimensional structure by a DLP photocuring or SLA photocuring printing method, which can be subjected to self-sustaining combustion in an oxygen-free environment.

The acrylate-terminated poly(glycidyl nitrate) of this disclosure can be prepared by the following synthesis route:

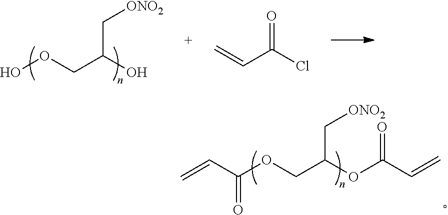

The preparation method of the acrylate-terminated poly(glycidyl nitrate) includes: a solution of acrylyl chloride in an organic solvent is added dropwise into a solution of poly(glycidyl nitrate) (PGN) in an organic solvent at −5 to 5° C., then a reaction is carried out to give acrylate-terminated poly(glycidyl nitrate). Optionally, the solution of PGN in an organic solvent is obtained by dissolving PGN in a mixture of methylene dichloride and triethylamine. Optionally, the solution of acrylyl chloride in an organic solvent is a solution of acrylyl chloride in methylene dichloride or a solution of acrylyl chloride in chloroform. A specific example of the preparation method is shown as follows. 100 g PGN is added in a reactor equipped with a mechanical stirring device and heated to 90° C., then water removal is performed under a reduced pressure for 1.5 h; then a resulting reaction system is cooled to room temperature, added with 500 mL methylene dichloride and triethylamine (3.735 g, 36.9 mmol), then cooled to 0° C. in an ice-salt bath, and added with 80 mL of the solution of acrylyl chloride (2.47 g, 27.3 mmol) in methylene dichloride dropwise over 6 h; after the addition is finished, the reaction is further performed for 24 h, then a reaction liquid is washed to neutral with water and separated to give an aqueous phase and an oil phase, the oil phase is distilled under a reduced pressure to remove the solvent therein, to give a product. The structure of the prepared product is identified by the nuclear magnetic spectrum, as shown in FIG. 3. In the nuclear magnetic spectrum of the prepared product: δ=1.2, 3.5 and 3.7 ppm represent the characteristic absorption peaks of PGN, and δ=5.9, 6.1 and 6.4 ppm represent the characteristic peaks of protons on the double bond (—CH═CH₂) at the end of the main chain of APGN, which indicates that the photosensitive energetic resin, APGN, is an acrylic modified PGN resin. In the nuclear magnetic carbon spectrum of APGN photosensitive energetic resin, δ=164.9 ppm represent the characteristic peak of the proton on the ester bond (—C═O) in the terminal acrylate group of APGN; δ=132.5 ppm and 127.3 ppm represent the characteristic peaks of the protons on the double bond in the terminal acrylate group of APGN; and δ=14.8, 26.3, and 68-72 ppm represent the characteristic peaks of protons of PGN.

In the infrared spectrogram: the peak at 1,128 cm⁻¹ is the infrared characteristic absorption peak of the —C—O— in the PGN, and the peak at 3,440 cm⁻¹ is the infrared absorption peak of terminal hydroxyl of PGN. After modification at terminal by the acrylate group, the infrared absorption peak of terminal hydroxyl of PGN at 3,440 cm⁻¹ disappears; and two obvious infrared characteristic absorption peaks at 1734 and 1190 cm⁻¹ appear with high absorbance, which are attributed to the C═O bond in the acrylate group. The identification data confirms that the prepared product is indeed acrylate-terminated poly(glycidyl nitrate) (APGN).

The following examples are used to further explain the disclosure, but the protection scope of this disclosure is not limited to the scope expressed in the examples. The ingredients used in the following examples are commercially available products or obtained by the existing methods or the preparation method provided herein.

### Example 1

A photocuable and combustible composition was obtained in this example by mixing the following ingredients by mass percentage:
Acrylate-terminated poly(3-nitratomethyl-3-methyloxetane): 50%;
Isobornyl acrylate: 20%;
Trimethylol propane triacrylate: 30%;
Ethyl 2,4,6-trimethylbenzoylphenylphosphonate: 3%, relative to a mass sum of the above three components.

### Example 2

A photocuable and combustible composition was obtained in this example by mixing the following ingredients by mass percentage:
Acrylate-terminated poly(glycidyl nitrate): 70%;
Ethoxylated ethoxyethyl acrylate: 10%;
Dipropylene glycol acrylate: 20%;
Phenyl bis(2,4,6-trimethyl benzoyl) phosphine oxide: 4%, relative to a mass sum of the above three components.

The HITech-DLP007B DLP photocuring 3D printing equipment, and HITech-DLP002A SLA photocuring 3D printing equipment were used in the following examples, to explain specific application of the composition of this disclosure. It should be noted that the application scope of the composition of this disclosure is not limited to the above two specific equipments and related processes, and any commercially available DLP and SLA photocuring printing equipment are applicable to the disclosure.

### Example 3

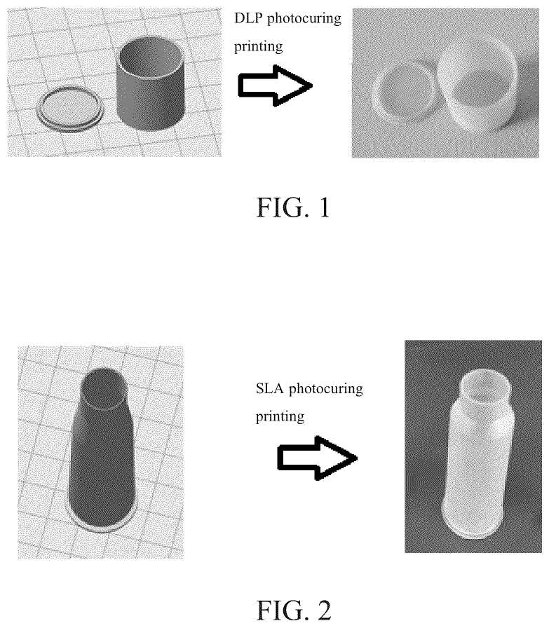

In this example, the composition prepared in Example 1 was used as a raw material, and a combustible ignition cartridge (including a cover body and a cartridge body) was obtained by 3D printing with DLP photocuring 3D printing equipment, using a 3D model, as shown in FIG. 1. In the specific process, parameters of the DLP photocuring 3D printing equipment were set as follows: a band of 405 nm, a resolution of 3,840×2,160 pixels, a exposure time of 1.5 s, and a layer height of 0.1 mm. The printing platform was moved down to drive the resin flow to form a new liquid layer, then the new liquid layer was photocured according to the scanned pattern, and the printing platform was continuously moved down to give a 3D model print.

### Example 4

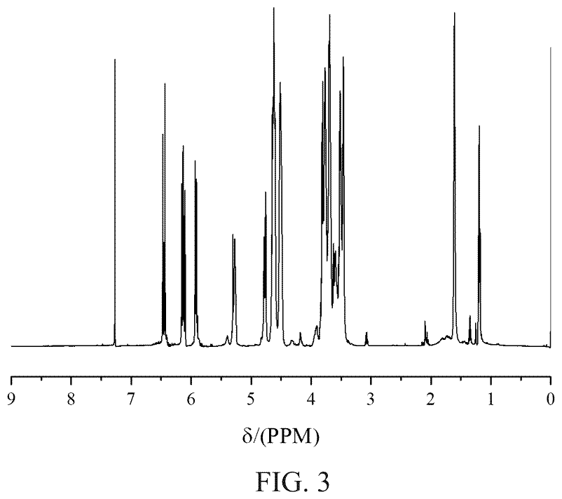

In this example, the composition prepared in Example 2 was used as a raw material, and a combustible cylindrantherae was obtained by 3D printing with SLA photocuring 3D printing equipment, using a 3D model, as shown in FIG. 2. In the specific process, the SLA photocuring 3D printing equipment was set as follows: a band of 405 nm, a laser spot diameter of 85 microns, a scanning speed of 8 m/s, and a layer height of 0.05 mm. The printing platform was moved down to drive the resin flow to form a new liquid layer, then the new liquid layer was photocured according to the scanned pattern, and the printing platform was continuously moved down to give a 3D model print.

The combustible components prepared in Examples 3 and 4 were subjected to a combustion test in a closed bomb filled with nitrogen at a certain pressure (used to exclude oxygen), according to the test method of “GJB770B 2005 Method 706.1 combustion rate target line method”. The measurement results were shown as follows: the combustible component prepared in Example 3 had a combustion rate of 0.9 mm/s under nitrogen at a pressure of 4 MPa, a combustion rate of 3.8 mm/s under nitrogen at a pressure of 11 MPa, and a combustion rate of 5.2 mm/s under nitrogen at a pressure of 16 MPa; the combustible component prepared in Example 4 had a combustion rate of 2.5 mm/s under nitrogen at a pressure of 4 MPa, a combustion rate of 7.3 mm/s under nitrogen at a pressure of 11 MPa, and a combustion rate of 10.1 mm/s under nitrogen at a pressure of 16 MPa. It can be determined that the combustible components prepared by the composition of this disclosure can realize self-sustaining combustion in an oxygen-free condition.

What is claimed is:

1. A photocurable and combustible composition, wherein the photocurable and combustible composition comprises an energetic prepolymer, a diluent and a photoinitiator;
the energetic prepolymer is one of or a mixture of two of acrylate-terminated poly(3-nitratomethyl-3-methyloxetane) (APNIMMO) and acrylate-terminated poly(glycidyl nitrate);
the diluent is one of or a mixture of at least two of isobornyl acrylate, isobornyl methacrylate, ethoxylated oxyphenyl acrylate, ethoxylated ethoxyethyl acrylate, dipropylene glycol acrylate, tripropylene glycol diacrylate, hexadiol diacrylate, propoxylated glycerol triacrylate, trimethylol propane triacrylate, ethoxylated trimethylol propane triacrylate, alkoxyylated pentaerythritol tetraacrylate and dimethylol propane tetraacrylate;
the photoinitiator is one of or a mixture of at least two of ethyl 2,4,6-trimethylbenzoylphenylphosphonate, phenyl bis(2,4,6-trimethyl benzoyl) phosphine oxide and 2,4,6-trimethylbenzoyl-diphenyl phosphine oxide.

2. The photocurable and combustible composition according to claim 1, wherein, a content of the energetic prepolymer is 30% to 80% by mass, a content of the diluent is 20% to 70% by mass, and a mass percentage sum of the energetic prepolymer and the diluent is 100%.

3. The photocurable and combustible composition according to claim 1, wherein, the photoinitiator is comprised in an amount of 0.3% to 5% by mass, relative to a mass sum of the energetic prepolymer and the diluent.

4. A combustible component, prepared by the photocurable and combustible composition according to claim 1.

5. A preparation method of a combustible component, wherein the photocurable and combustible composition according to claim 1 is used as a raw material, and the combustible component is prepared by a DLP photocuring 3D printing method or a SLA photocuring 3D printing method.

6. The preparation method according to claim 5, wherein the combustible component is a combustible cartridge, a combustible cylindrantherae or a combustible igniting primer.

7. The preparation method according to claim 6, wherein the combustible cartridge is a combustible ignition cartridge.
